(19) United States
(12) Patent Application Publication
(10) Pub. No.: US 2017/0337220 A1
(43) Pub. Date: Nov. 23, 2017

(54) Methods and Systems for Automatically Generating Accessibility Descriptions of Data Visualizations

(71) Applicant: Open Access Technologies, Inc., Nashua, NH (US)

(72) Inventors: Jonathan Brett Metz, Washington, DC (US); Michael G. Paciello, Hudson, NH (US); Georges Grinstein, Hadley, MA (US); Joseph S. Stubblefield, Dunstable, MA (US); Franck Kamayou, Chelmsford, MA (US)

(21) Appl. No.: 15/595,023

(22) Filed: May 15, 2017

Related U.S. Application Data
(60) Provisional application No. 62/338,225, filed on May 18, 2016.

(51) Int. Cl. G06F 17/30; G06F 17/27; G06F 17/24; G09B 21/00; G06K 9/62

(52) U.S. Cl. CPC G06F 17/30247; G09B 21/006; G06K 9/6267; G06F 17/241; G06F 17/2705; G06K 9/6201

(57) ABSTRACT

A method for automatically generating an accessibility description of a data visualization object includes analyzing, by an automatic description generator executing on a computing device, an image object including at least one data visualization object. The method includes identifying at least one attribute of the image object, based on the analysis. The method includes receiving an identification of at least one data source for the at least one data visualization object. The method includes determining at least one mathematical value describing at least one characteristic of the data visualization object, based on the identified at least one attribute of the image object and the identified at least one data source. The method includes automatically generating a text-based description of the at least one characteristic, the text-based description including the at least one mathematical value. The method includes incorporating, the generated text-based description into a resource satisfying an accessibility requirement.

### CROSS-REFERENCE TO RELATED APPLICATIONS

This application claims priority to U.S. Provisional Patent Application No. 62/338,225, filed on May 18, 2016, entitled “Method and System for Automatically Generating Accessibility Descriptions of Data Visualizations,” which is hereby incorporated by reference and in its entirety.

### BACKGROUND

The disclosure relates to descriptions of data visualization objects. More particularly, the methods and systems described herein relate to functionality for automatically generating accessibility descriptions of data visualization objects.

The Portable Document Format (PDF) is a universal document file format for electronic images of text, graphics, or both, and provides a universal document file that enables the exchange of electronic document documents. To comply with accessibility standards, PDF documents typically need to support navigation and audio descriptions of non-text based objects; for example, by providing an alternative, accessible format for embedded image objects. As an example of an accessibility standard, section 508 of the Rehabilitation Act of 1973, as amended (29 U.S.C. 794d) requires that when federal agencies develop, procure, maintain, or use electronic and information technology, federal employees with disabilities have access to and use of information and data that is comparable to the access and use by federal employees who are not individuals with disabilities; Section 508 also requires that individuals with disabilities, who are members of the public seeking information or services from a federal agency, have access to and use of information and data that is comparable to that provided to the public who are not individuals with disabilities.

Conventional systems for generating compliant PDF documents typically require either the manual or automatic generation of alternative text. Those conventional systems that provide automation of the process typically fail to analyze underlying data or attributes of image objects to generate descriptions, relying instead on, for example, template layouts of similar documents to select a predefined description of a section likely to be included in the document or to select a predetermined generic description. By way of example, a conventional system may determine that a document is a bill, access a manually generated template of bills, and generate descriptions of the document based on the descriptions included in the manually generated template. Conventional systems typically fail to analyze embedded data visualization objects and underlying data sources to automatically generate descriptions of the embedded objects.

### BRIEF SUMMARY

In one aspect, a method for automatically generating an accessibility description of a data visualization object includes analyzing, by an automatic description generator executing on a computing device, an image object including at least one data visualization object. The method includes identifying, by the automatic description generator, at least one attribute of the image object, based on the analysis. The method includes receiving, by the automatic description generator, an identification of at least one data source for the at least one data visualization object. The method includes determining, by the automatic description generator, at least one mathematical value describing at least one characteristic of the data visualization object, based on the identified at least one attribute of the image object and the identified at least one data source. The method includes automatically generating, by the automatic description generator, a text-based description of the at least one characteristic, the text-based description including the at least one mathematical value. The method includes incorporating, by the automatic description generator, into a resource satisfying an accessibility requirement, the generated text-based description.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C are block diagrams depicting embodiments of computers useful in connection with the methods and systems described herein;

FIG. 2A is a block diagram depicting an embodiment of a system for automatically generating an accessibility description of data visualization objects;

FIG. 2B is a block diagram depicting an embodiment of a data visualization object in a system for automatically generating an accessibility description of data visualization objects;

FIG. 2C is a block diagram depicting an embodiment of an automatically generated text-based description in a system for automatically generating an accessibility description of data visualization objects; and

FIG. 3 is a flow diagram depicting an embodiment of a method for automatically generating an accessibility description of data visualization objects.

### DETAILED DESCRIPTION

In some embodiments, the methods and systems described herein provide functionality for automatically generating accessibility descriptions of data visualization objects. Before describing these methods and systems in detail, however, a description is provided of a network in which such methods and systems may be implemented.

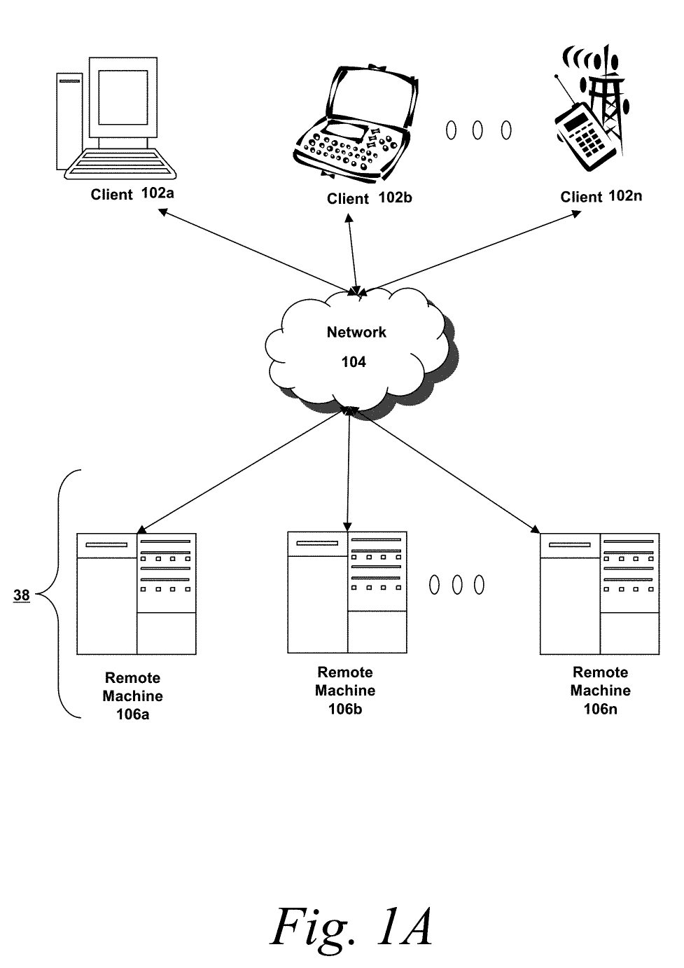

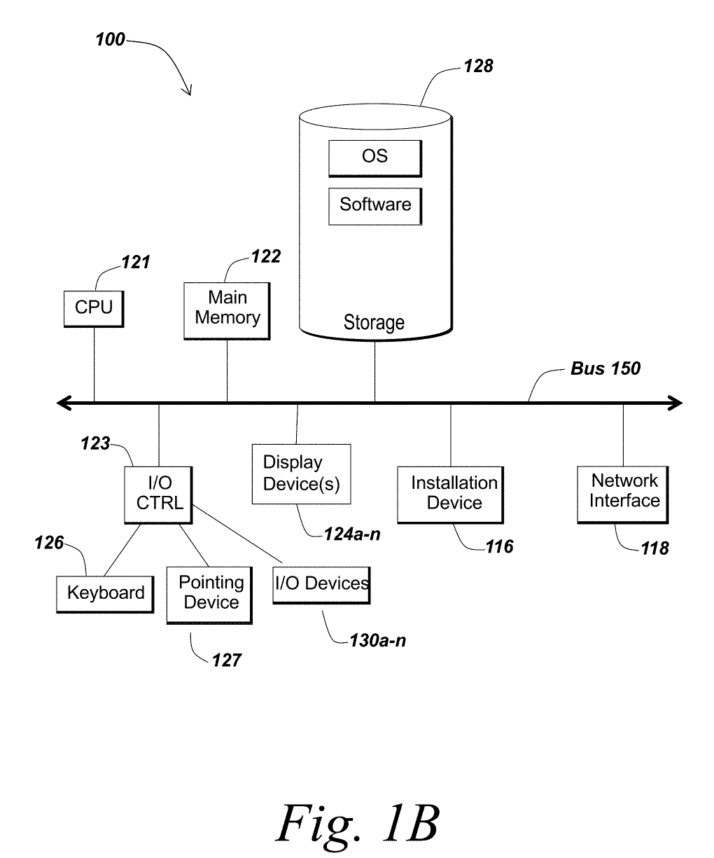

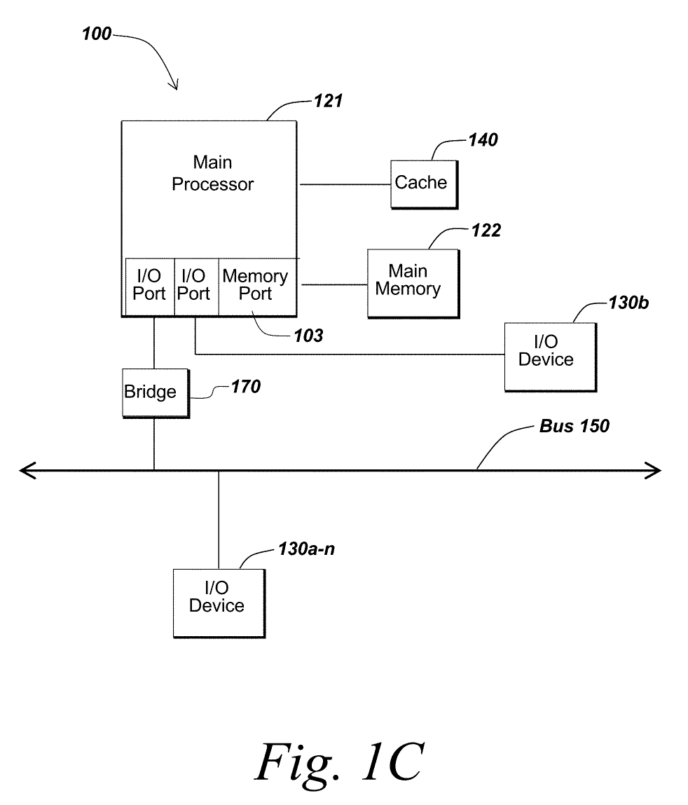

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices (including tablets and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 102 and a remote machine 106 (referred to generally as computing devices 100) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on client 102.

In one embodiment, a computing device 106 provides the functionality of a web server. In some embodiments, a web server 106 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, Wash., the ORACLE IPLANET web server products provided by Oracle Corporation of Redwood Shores, Calif., or the BEA WEBLOGIC products provided by BEA Systems of Santa Clara, Calif.

In some embodiments, the system may include multiple, logically-grouped remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. Other examples include SPARC processors, ARM processors, processors used to build UNIX/LINUX “white” boxes, and processors for mobile devices. The computing device 100 may be based on any of these processors, or any other processor capable of operating as described herein.

Main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. The I/O devices may be controlled by an I/O controller 123 as shown in FIG. 1B. Furthermore, an I/O device may also provide storage and/or an installation medium 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 1B, the computing device 100 may support any suitable installation device 116, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 100 may provide functionality for installing software over a network 104. The computing device 100 may further comprise a storage device, such as one or more hard disk drives or redundant arrays of independent disks, for storing an operating system and other software. Alternatively, the computing device 100 may rely on memory chips for storage instead of hard disks.

Furthermore, the computing device 100 may include a network interface 118 to interface to the network 104 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In some embodiments, the computing device 100 may comprise or be connected to multiple display devices 124a-124n, each of which may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, and WINDOWS VISTA, all of which are manufactured by Microsoft Corporation of Redmond, Wash.; MAC OS manufactured by Apple Inc. of Cupertino, Calif.; OS/2 manufactured by International Business Machines of Armonk, N.Y.; Red Hat Enterprise Linux, a Linus-variant operating system distributed by Red Hat, Inc. of Raleigh, N.C.; Ubuntu, a freely-available operating system distributed by Canonical Ltd. of London, England; or any type and/or form of a UNIX operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments, the computing device 100 is a mobile device, such as a JAVA-enabled cellular telephone/smartphone or personal digital assistant (PDA). The computing device 100 may be a mobile device such as those manufactured, by way of example and without limitation, by Apple Inc. of Cupertino, Calif.; Google/Motorola Div. of Ft. Worth, Tex.; Kyocera of Kyoto, Japan; Samsung Electronics Co., Ltd. of Seoul, Korea; Nokia of Finland; Hewlett-Packard Development Company, L.P. and/or Palm, Inc. of Sunnyvale, Calif.; Sony Ericsson Mobile Communications AB of Lund, Sweden; or Research In Motion Limited of Waterloo, Ontario, Canada. In yet other embodiments, the computing device 100 is a smartphone, POCKET PC, POCKET PC PHONE, or other portable mobile device supporting Microsoft Windows Mobile Software.

In some embodiments, the computing device 100 is a digital audio player. In one of these embodiments, the computing device 100 is a digital audio player such as the Apple IPOD, IPOD TOUCH, IPOD NANO, and IPOD SHUFFLE lines of devices manufactured by Apple Inc. In another of these embodiments, the digital audio player may function as both a portable media player and as a mass storage device. In other embodiments, the computing device 100 is a digital audio player such as those manufactured by, for example, and without limitation, Samsung Electronics America of Ridgefield Park, N.J., or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats, and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a device in the Google/Motorola line of combination digital audio players and mobile phones. In another of these embodiments, the computing device 100 is a device in the IPHONE smartphone line of devices manufactured by Apple Inc. In still another of these embodiments, the computing device 100 is a device executing the ANDROID open source mobile phone platform distributed by the Open Handset Alliance; for example, the device 100 may be a device such as those provided by Samsung Electronics of Seoul, Korea, or HTC Headquarters of Taiwan, R.O.C. In other embodiments, the computing device 100 is a tablet device such as, for example and without limitation, the IPAD line of devices manufactured by Apple Inc.; the PLAYBOOK manufactured by Research In Motion; the CRUZ line of devices manufactured by Velocity Micro, Inc. of Richmond, Va.; the FOLIO and THRIVE line of devices manufactured by Toshiba America Information Systems, Inc. of Irvine, Calif.; the GALAXY line of devices manufactured by Samsung; the HP SLATE line of devices manufactured by Hewlett-Packard; and the STREAK line of devices manufactured by Dell, Inc. of Round Rock, Tex.

In some embodiments, the methods and systems described herein provide functionality for automatically generating an accessibility description of data visualization objects. The methods and systems described herein may leverage data within a document containing a data visualization object to generate the accessibility description. The methods and systems described herein may leverage both underlying data sources (e.g., sources of data being represented by the data visualization object) and attributes of the data visualization object itself to generate the accessibility description. Although the examples described herein relate to documents formatted according to a Portable Document Format (PDF), it will be understood that the methods and systems described herein may be applied to any type or form of document, including without limitation, Advanced Function Printing (AFP) documents, POSTSCRIPT documents, Tagged Image File Format (TIFF) and other image formats (e.g., JPG and PNG), Xerox Metacode documents, Printer Command Language (PCL) documents, or word processing documents (e.g., Microsoft WORD documents, Apple PAGES documents, and open source text documents). In some embodiments, the methods and systems described herein provide functionality for annotating, with varying level of detail, data visualization objects that are embedded within documents.

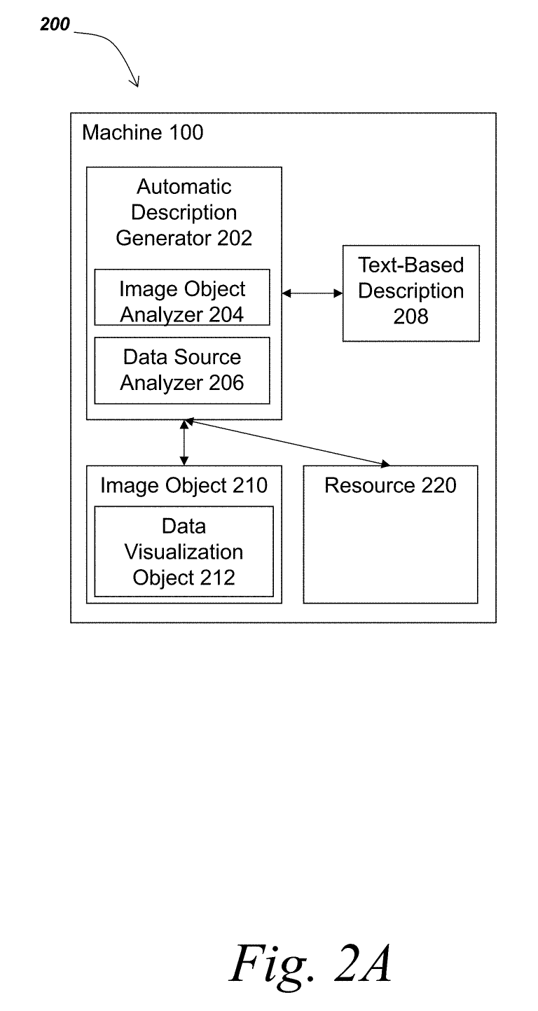

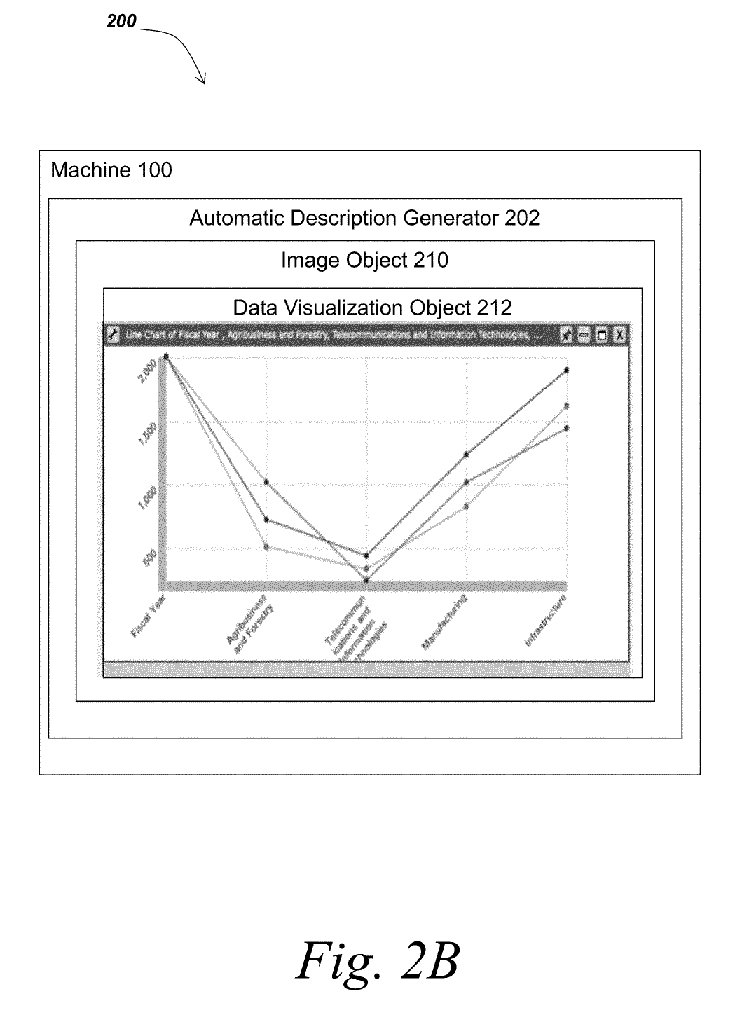

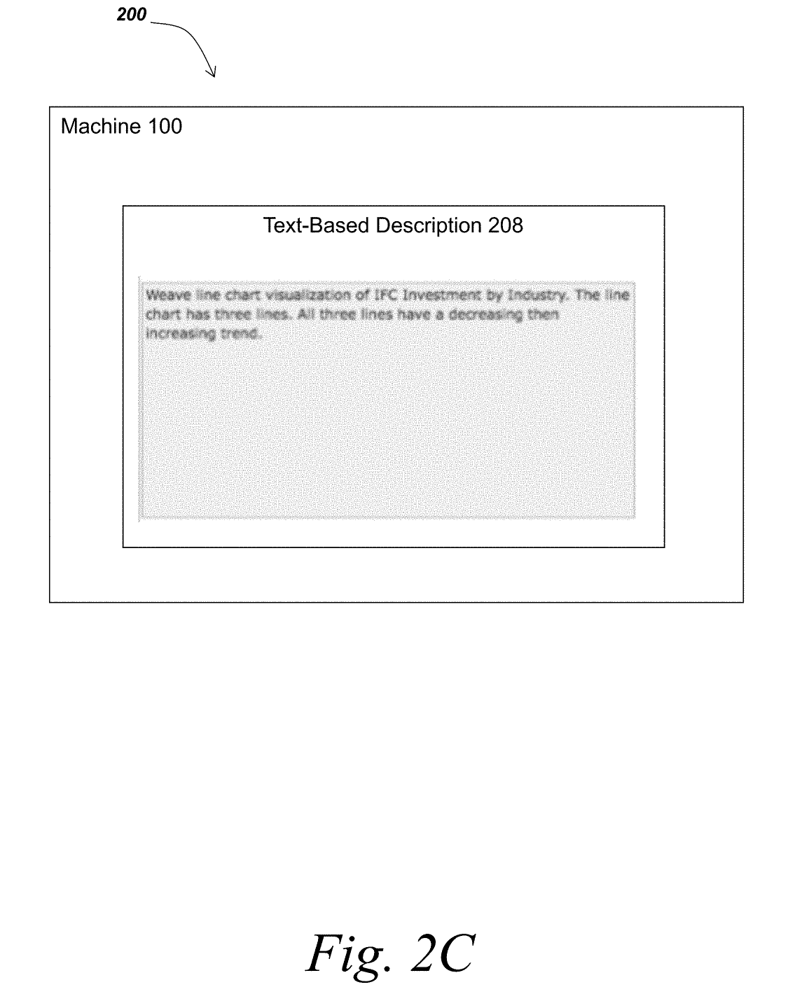

Referring now to FIG. 2A, a block diagram depicts one embodiment of a system for automatically generating an accessibility description of data visualization objects. In brief overview, the system includes an automatic description generator 202 executing on a machine 100. The automatic description generator 202 includes an image object analyzer 204 and a data source analyzer 206. The automatic description generator 202 accesses an image object 210, a data visualization object 212, and a resource 220. The automatic description generator 202 generates a text-based description 208.

In one embodiment, the automatic description generator 202 is implemented in software. In another embodiment, the automatic description generator 202 is implemented in hardware.

In one embodiment, the image object analyzer 204 is implemented in software. In another embodiment, the image object analyzer 204 is implemented in hardware.

In one embodiment, the data source analyzer 206 is implemented in software. In another embodiment, the data source analyzer 206 is implemented in hardware.

In some embodiments, the machine 100 is connected to a client machine 102 (not shown). In one of these embodiments, the automatic description generator 202 is part of a web-based visualization and analysis environment; for example, the automatic description generator 202 may be a plug-in, add-on, or other sub-component of standalone or web-based software for generating data visualization objects, images including those data visualization objects, and electronic documents (including, without limitation, reports, presentations, and electronic documents generally).

Referring now to FIG. 2B, a block diagram depicting an embodiment of a data visualization object in a system for automatically generating an accessibility description of data visualization objects. As shown in FIG. 2B, the data visualization object 212 may be a line chart visually depicting an underlying data set. Although the embodiment depicted in FIG. 2B is a line chart, it will be understood that any type of data visualization object may be used, including without limitation, bar charts, pie charts, scatter plots, histograms, maps, three-dimensional scatter plots, Gantt charts, tree maps, radial visualizations, and heat maps.

As shown in FIG. 2B, the image object 210 may include other elements than just the data visualization object 212 (e.g., a graphical user interface for interacting with or modifying the data visualization object 212, text describing the data visualization object 212 (such as the title bar, subtitle, or annotations), and other elements). Although not depicted in FIG. 2B, an image object 210 may include multiple data visualization objects 212.

Referring now to FIG. 2C, a block diagram depicting an embodiment of an automatically generated text-based description 208 in a system for automatically generating an accessibility description of data visualization objects. As shown in FIG. 2C, the text-based description 208 may include data derived from an analysis of the data visualization object 212 (e.g., “Weave line chart visualization of IFC Investment by Industry. The line chart has three lines.”). The text-based description may also include data derived from mathematical or statistical analysis of both the underlying data and at least one characteristic of the data visualization object 212 (e.g., “All three lines have a decreasing then increasing trend.”).

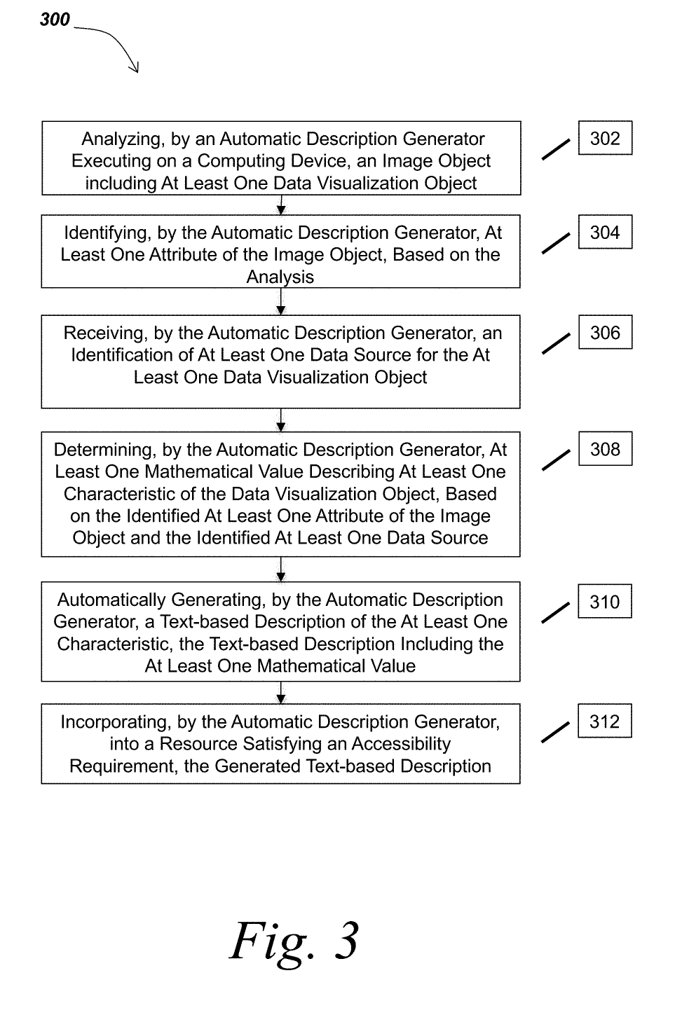

Referring now to FIG. 3, and in connection with FIGS. 2A-2C, a flow diagram depicts one embodiment of a method 300 for automatically generating accessibility descriptions of data visualization objects. In brief overview, the method 300 includes analyzing, by an automatic description generator executing on a computing device, an image object including at least one data visualization object (302). The method 300 includes identifying, by the automatic description generator, at least one attribute of the image object, based on the analysis (304). The method 300 includes receiving, by the automatic description generator, an identification of at least one data source for the at least one data visualization object (306). The method 300 includes determining, by the automatic description generator, at least one mathematical value describing at least one characteristic of the data visualization object, based on the identified at least one attribute of the image object and the identified at least one data source (308). The method 300 includes automatically generating, by the automatic description generator, a text-based description of the at least one characteristic, the text-based description including the at least one mathematical value (310). The method 300 includes incorporating, by the automatic description generator, into a resource satisfying an accessibility requirement, the generated text-based description (312).

Referring now to FIG. 3 in greater detail, and in connection with FIG. 2A-2C, the method 300 includes analyzing, by an automatic description generator executing on a computing device, an image object including at least one data visualization object (302). In one embodiment, a user provides an identification of the image object. In another embodiment, the user is accessing the computing device across a network connection and interacts with a graphical user interface to generate, analyze, modify, manipulate, and otherwise interact with image objects; in such an embodiment, the user may be accessing a web-based software application that includes the functionality of the automatic description generator 202. In other embodiments, the user is accessing a standalone software application (which may be accessed directly or across a network) for generating electronic documents (e.g., PDFs) in which image objects have been embedded (e.g., a PDF writer); in such an embodiment, the standalone software application includes the functionality of the automatic description generator 202. In one embodiment, the automatic description generator 202 has access to both the image object 210 and to a data source underlying data visualized by the data visualization object 212. In some embodiments, the automatic description generator 202 receives an identification of a location of the data source from a user.

The method 300 includes identifying, by the automatic description generator, at least one attribute of the image object, based on the analysis (304). In some embodiments, the image object analyzer 204 analyzes the image object 210 to identify the at least one attribute of the image object 210. The at least one attribute may include, without limitation, how many data visualization objects 212 are included in the image object 210. The at least one attribute may include text within the image object 210, such as legends, titles, sub-titles, annotations, labels, or other text included in the image object 210. In other embodiments, the image object analyzer 204 analyzes the image object 210 to identify the at least one attribute of the data visualization object 212. The at least one attribute may include, without limitation, axes, ranges, minima, maxima, legends, titles, values, tick marks, points, lines, areas, and data values.

The method 300 includes receiving, by the automatic description generator, an identification of at least one data source for the at least one data visualization object (306). In some embodiments, the automatic description generator 202 receives an identification of a location of the data source from a user (e.g., via a graphical user interface).

The method 300 includes determining, by the automatic description generator, at least one mathematical value describing at least one characteristic of the data visualization object, based on the identified at least one attribute of the image object and the identified at least one data source (308). In one embodiment, the automatic description generator 202 generates a set of mathematical approximations and statistical values for the visualized data, using the visualization constraints (e.g., axes and attributes from the image object 210). In another embodiment, the automatic description generator 202 computes mathematical values including, without limitation, mean, standard deviations, trends, and correlations. In still another embodiment, the at least one mathematical value provides a description of structural aspects of the data visualization object including, without limitation, groupings, trends, anomalies, outliers, and other descriptions. In another embodiment, the at least one mathematical value includes mathematical computations on and about the data and the visualization, including clusters, trends, and other characteristics.

The method 300 includes automatically generating, by the automatic description generator, a text-based description of the at least one characteristic, the text-based description including the at least one mathematical value (310). In one embodiment, the automatic description generator 202 accesses an ontology associated with a domain of application (e.g., of the data) and with the visualization to generate the text-based description. In another embodiment, the automatic description generator 202 applies natural language processing to generate the text-based description. In still another embodiment, the automatic description generator 202 accesses one or more deep neural networks to generate the text-based description. In another embodiment, the automatic description generator 202 modifies predefined message templates to incorporate a description of the at least one mathematical value. In yet another embodiment, the automatic description generator 202 maps the at least one mathematical value to neural networks of textual messages, tuned by ontology. For example, a domain ontology may enable the system to determine word phrases appropriate to the domain. In some embodiments, the automatic description generator 202 generates a plurality of text-based descriptions, each of the plurality providing a different level of detail.

The automatic description generator 202 may display, to a user of the computing device, the automatically generated text-based description. The computing device 100 may transmit, to a second computing device, the automatically generated text-based description for display to a user of the second computing device.

The method 300 includes incorporating, by the automatic description generator, into a resource satisfying an accessibility requirement, the generated text-based description (312). In some embodiments, the automatic description generator 202 processes each of a plurality of visual elements (including, without limitation, tables, charts, images, and videos). In one of these embodiments, the automatic description generator 202 generates a text-based description of each of the plurality of visual elements. In another of these embodiments, the automatic description generator 202 incorporates each of the text-based descriptions into a resource 220. By way of example, and without limitation, the resource 220 may be a PDF document, a logical structure (or “tag tree” or “logical structure tree” or “tag structure”), a document in eXtended Markup Language (XML), or other electronic file. As another example, the automatic description generator 202 may generate a tag that includes a text-based description and incorporate the tag into a PDF document containing the embedded data visualization object described by the tag. As another example, the automatic description generator 202 may generate a tag that includes a text-based description and incorporate the tag into a tag structure accompanying a PDF document containing the embedded data visualization object described by the tag. As further examples, the automatic description generator 202 may insert the text-based description as “alt text” within a web page, set up a report including the text-based description, or pass the text-based description in response to an Application Programming Interface (API) call.

In some embodiments, therefore, the methods and systems described herein provide functionality for automatically generating an accessibility description of data visualization objects. In some embodiments, the methods and systems described herein support functionality for generating textual descriptions that are available at different levels of detail, from a lowest level that simply describes an attribute of a data visualization up to higher level descriptions that provide more detailed descriptions (e.g., identifying general trends, trends on each subcomponent of the data visualization, identification of mathematical properties such as slope, averages, and indication of changes to curvature). In other embodiments, the methods and systems described herein support functionality for reading text for sighted individuals—reports, for example, can be read when someone is driving (again, at different levels of details). A person listening to such a report could stop and ask a question requesting more details. Hence, the level of details could be interactively determined.

Although for ease of discussion the components of the system 200 are described as separate modules, it should be understood that this does not restrict the architecture to a particular implementation. For instance, these modules may be encompassed by a single circuit or software function; alternatively, they may be distributed across a plurality of machines 100. Furthermore, in some embodiments, the components of the system 200 may be provided as a plug-in, add-on, or other sub-component of standalone or web-based software for generating data visualization objects, images including those data visualization objects, and electronic documents (including, without limitation, reports, presentations, and electronic documents generally); therefore, the system 200 may be provided as either a standalone product or provided as a service in a distributed manner.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

Having described certain embodiments of methods and systems for automatically generating accessibility descriptions of data visualization objects, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for automatically generating an accessibility description of a data visualization object, the method comprising:
analyzing, by an automatic description generator executing on a computing device, an image object including at least one data visualization object;
identifying, by the automatic description generator, at least one attribute of the image object, based on the analysis;
receiving, by the automatic description generator, an identification of at least one data source for the at least one data visualization object;
determining, by the automatic description generator, at least one mathematical value describing at least one characteristic of the data visualization object, based on the identified at least one attribute of the image object and the identified at least one data source;
automatically generating, by the automatic description generator, a text-based description of the at least one characteristic, the text-based description including the at least one mathematical value;
incorporating, by the automatic description generator, into a resource satisfying an accessibility requirement, the generated text-based description.

2. The method of claim 1, wherein identifying further comprises identifying, by the automatic description generator, at least one axis of the at least one data visualization object.

3. The method of claim 1, wherein identifying further comprises identifying, by the automatic description generator, a legend of the at least one data visualization object.

4. The method of claim 1, wherein identifying further comprises identifying, by the automatic description generator, a title of the at least one data visualization object.

5. The method of claim 1, wherein identifying further comprises identifying, by the automatic description generator, a legend of the at least one data visualization object.

6. The method of claim 1, wherein identifying further comprises identifying, by the automatic description generator, a data value of the at least one data visualization object.

7. The method of claim 1, wherein identifying further comprises identifying, by the automatic description generator, an annotation of the at least one data visualization object.

8. The method of claim 1, wherein determining further comprises computing a mathematical value describing a structural aspect of the data visualization object.

9. The method of claim 1, wherein incorporating further comprises incorporating, by the automatic description generator, into a document formatted according to a portable document format (PDF), a tag including the text-based description.

10. The method of claim 1 further comprising displaying, in a user interface, to a user of the computing device, the automatically generated text-based description.

11. The method of claim 1 further comprising transmitting, by the computing device, to a second computing device, the automatically generated text-based description for display to a user of the second computing device.

12. A non-transitory computer readable medium comprising computer program instructions tangibly stored on the computer readable medium, wherein the computer program instructions are executable by at least one computer processor to perform a method for automatically generating an accessibility description of a data visualization object, the method comprising:
analyzing, by an automatic description generator executing on a computing device, an image object including at least one data visualization object;
identifying, by the automatic description generator, at least one attribute of the image object, based on the analysis;
receiving, by the automatic description generator, an identification of at least one data source for the at least one data visualization object;
determining, by the automatic description generator, at least one mathematical value describing at least one characteristic of the data visualization object, based on the identified at least one attribute of the image object and the identified at least one data source;
automatically generating, by the automatic description generator, a text-based description of the at least one characteristic, the text-based description including the at least one mathematical value;
incorporating, by the automatic description generator, into a resource satisfying an accessibility requirement, the generated text-based description.
